(19) United States
(12) Patent Application Publication
(10) Pub. No.: US 2004/0041508 A1
(43) Pub. Date: Mar. 4, 2004

(54) Electrode and device using the same

(76) Inventors: Takashi Sugino, Osaka (JP); Masaki Kusuhara, Tokyo (JP); Masaru Umeda, Tokyo (JP)

Correspondence Address: RANDALL J. KNUTH, P.C., 3510-A Stellhorn Road, Fort Wayne, IN, 46815-4631, US

(21) Appl. No.: 10/379,968

(22) Filed: Mar. 5, 2003

(30) Foreign Application Priority Data
Apr. 19, 2002 (JP) 2002-118615
Sep. 5, 2002 (JP) 2002-260682

(51) Int. Cl. H01J 1/02

(52) U.S. Cl. 313/309

(57) ABSTRACT

A high-efficiency electron-emitting device that can emit electron with higher luminance at a voltage lower than conventional electron-emitting devices, as a key device of a flat panel display, image pickup device, electron beam device, microwave traveling-wave tube is provided to improve the carrier injection efficiency and enhance luminance of an organic light-emitting device.

A film having space charge with a thickness of 50 nm or less is formed on a surface of a conductive material on which irregularities, amorphous or fibrous materials are formed. The film includes compounds of group 3 atoms such as aluminum nitride, boron nitride, aluminum nitride boron, aluminum nitride gallium, boron nitride gallium and nitrogen atoms, and nitride, carbon, silicon, oxygen and boron such as oxides including nitrogen boron carbon, boron carbide, carbon nitride, boron.

### BACKGROUND OF THE INVENTION

1. Technical Field

The present invention relates to an electrode to inject and emit carrier effectively and a device using the same.

2. Background Art

A cold cathode can be applied to a field emission display, electron beam exposure, microwave traveling wave tube, image pickup device and so on. It can be also used as an electrode source of a material evaluation device such as an Auger electron spectroscopy using electron beam. Further, it can be used as a light-emitting element for an illumination device or an indicator lamp and other varied applications.

With regard to a cold cathode, an electron-emitting device called spint-type forming a spire using a metal or silicon has been researched and developed. However, low voltage operation, high current operation and reliability of a device have been required in the applications shown above. Under such circumstances, improvement of characteristics of a spint-type cold cathode and new materials for cold cathodes have been researched and developed. Diamonds, aluminum nitride, boron nitride have become a focus of attention as one of materials having negative electron affinity. Recently, syntheses of materials such as carbon nanotubes or carbon nanofibers that can enlarge the electric field concentration factors have been improved significantly and electron emissions at lower voltage have been observed. Applications for a field emission display are expected. However, there were problems about spatial stability in electron emission characteristics of these carbon nanotubes or carbon nanofiber. Further, low voltage operation and high current operation are required.

Moreover, even in an organic light-emitting element which has been developed recently, a problem about carrier injection still remains. Therefore, further improvement in performance is required.

### OBJECT AND GENERAL DESCRIPTION OF THE INVENTION

Under such circumstances, with regard to improvement of characteristics of spint-type cold cathode, coatings of varied materials on surfaces have been discussed. Moreover, coating technologies have become a focus of attention in order to improve spatial stability in electron emissions from carbon nanotubes or carbon nanofibers. Although, several trials have been carried out so far, it is required to realize more excellent electron emission characteristics, it is required to improve the carrier injection efficiency in development of organic light-emitting element.

An object of the present invention is to provide an electrode to realize more effective emission and injection of carriers than before, regarding to the circumstances mentioned above.

In order to achieve the object mentioned above, an electrode of the present invention has a film on a conductive material to supply carriers and the film includes space charge. When emitting or injecting electrons with an electrode of the present invention, positive space charges are used in the film. When electron holes are injected, negative space charges are used in the film. Higher density of space charge is more preferable. Density of 1×10¹⁷ cm⁻³ or more is effective.

In addition, metals, semiconductors and graphite can be used for the conductive material.

Further, a surface of the conductive material is characterized by having irregularities or spires. This type of surface can enhance the electric field strength on the surface and efficiency to inject carrier into a film including space charge.

Moreover, a surface of a conductive material is characterized by having indeterminate form or fibrous metals, and by using semiconductors or graphite. Metal flakes, fibers, and carbon nanotubes can be used to enhance the electric field strength on a surface. As mentioned above, it is possible to enhance efficiency to inject carriers into film including space charges.

The film is characterized by including any one of amorphous, crystal grain boundary or impurity atoms.

The film is also characterized by having a thickness of 50 nm or less. A thickness of 10 nm or less shows significant effect and the thinner a film becomes, the higher the effect is. However, 5 to 8 nm is preferable when considering manufacturing process.

An electron-emitting device according to the present invention comprises the electrode as a cathode.

If an electron-emitting device according to the present invention is used for a field emission display, low voltage operation and clear images can be realized.

If an electron-emitting device according to the present invention is used for an electron beam exposure, an electron beam exposure with high resolution and enhanced throughput can be realized.

If an electron-emitting device according to the present invention is used for a microwave traveling-wave tube, high-power microwave output can be obtained.

If an electron-emitting device according to the present invention is used for an image pickup device, clear images can be realized.

If an electron-emitting device according to the present invention is used for an electron beam source of a material evaluation device, it is possible to expect enhanced evaluation accuracy.

In addition, it is characterized in that an electrode according to the present invention can be used for an electrode of a light-emitting element. If an electrode according to the present invention is used for a light-emitting element, vivid emission with high-luminance can be obtained as well as superior illumination and display can be realized.

If a light-emitting element using an electrode according to the present invention is used for a backlight of a liquid crystal display, a liquid crystal display with high-luminance and less power consumption can be realized.

In addition, a plasma display according to the present invention is characterized by using the electrode as an electrode of a discharge cell in.

An organic light-emitting device according to the present invention comprises the electrode. If an electrode according to the present invention is used in an organic light-emitting device, vivid emission with high luminance and a high quality display device can be realized.

### BRIEF DESCRIPTION OF THE DRAWINGS

FIG. 1 is a cross-sectional view of a first embodiment of an electron-emitting device according to the present invention;

FIG. 2 is a cross-sectional view of a second embodiment of an electron-emitting device according to the present invention;

FIG. 3 is a cross-sectional view of a third embodiment of an electron-emitting device according to the present invention;

FIG. 4 is a cross-sectional view of a fourth embodiment of an electron-emitting device according to the present invention;

FIG. 5 is a cross-sectional view of a fifth embodiment of a light-emitting element according to the present invention;

FIG. 6 is a cross-sectional view of a sixth embodiment of an organic light-emitting element according to the present invention.

### EXPLANATION OF REFERENCES

21, 31, 41, 51 Substrate

2, 22, 32, 42, 52 Film

23, 33, 43 SiOx Film

24, 34, 44, 54 Extraction electrode

5, 25, 35, 45, 55 Anode electrode

6, 26, 36, 7, 27, 37, 46, 47 Power source

8, 28, 38, 58 Cathode electrode

29 Spire part

30 Gallium nitride layer

40, 50 carbon nanotube or carbon nanofiber

510 Fluorescent material

511 Glass tube

61 Glass substrate

62 Anode

63 Hole transporting layer

64 Emitting layer

65 Cathode

66 Boron nitride thin film

67 Metal

### DETAILED DESCRIPTION OF BEST MODE FOR THE INVENTION

Embodiments of the present invention will be explained now. The electrode according to the present invention is composed of a film, having a thickness of 50 nm or less, which has space charge corresponding to the present invention on a conductive material surface, and the surface having a carbon nanotube or a carbon nanofiber formed on a conductive material. The use of an electrode of the present invention as a cathode gives an effect on improvement of the characteristic and the reliability of the conventional electron-emitting device. Moreover, it becomes possible to provide a material evaluation device of materials with a field emission display, an electron beam exposure, a microwave traveling-wave tube, an image pickup device and an electron beam by using the electron-emitting device of the present invention. Further, providing a light-emitting device and a high-efficiency organic light-emitting device becomes possible by the use of the electrode according to the present invention.

Embodiments

Specific embodiments of the electron-emitting device, the light-emitting device, and the organic light-emitting device according to the present invention will be explained now.

(Embodiment 1)

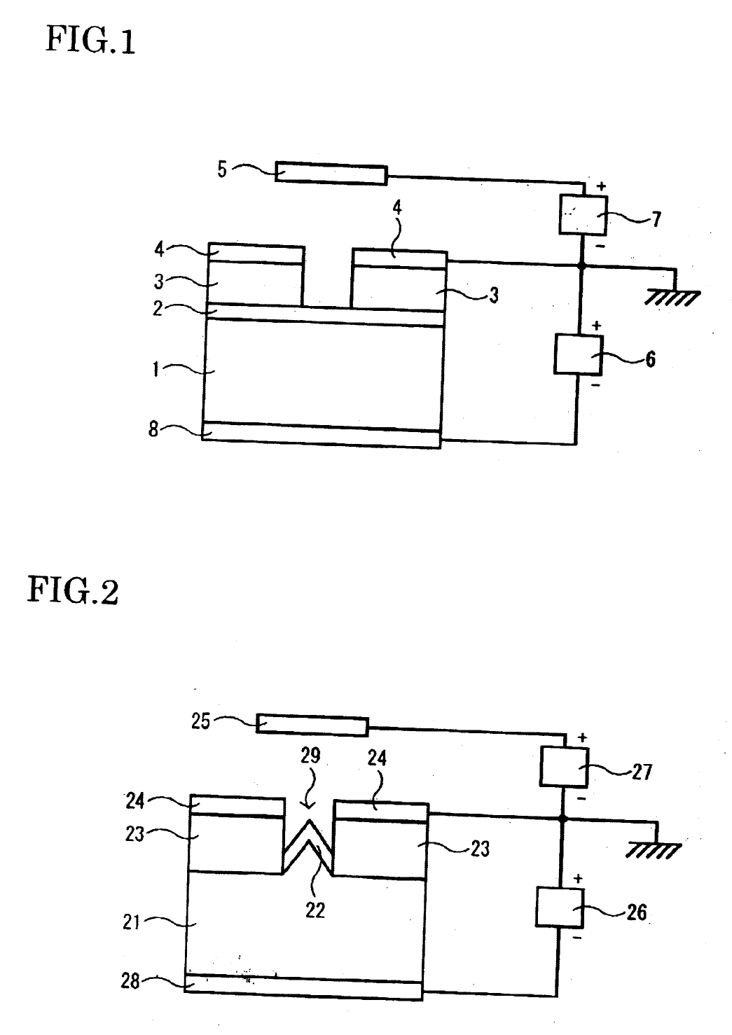

FIG. 1 is a schematic cross-sectional view of a first embodiment of an electron-emitting device according to the present invention. An electron-emitting device of embodiment 1 is composed of a substrate 1, a boron nitride thin film 2, a SiOx film 3, an extraction electrode 4, an anode electrode 5, a power source 6, 7, a cathode electrode 8.

In this embodiment, silicon was used for the substrate 1. On the substrate, 10 nm of the boron nitride thin film 2 was deposited by the plasma chemical vapor deposition (CVD) method using boron trichloride and nitrogen gas. Next, sulfur atoms were added to the boron nitride thin film 2 by concentration of 1×10¹⁸ cm⁻³. Further, 800 nm of the SiOx thin film 3 and Ti (20 nm)/Au (500 nm) as a metal for the extraction electrode 4 were formed on the boron nitride thin film 2 by the electron-beam evaporation method. Still further, AL (500 nm) as the cathode electrode 8 was electron-beam evaporated on the backside of the silicon substrate 1. After that, a metal for the extraction electrode 4 and the SiOx thin film 3 were removed by etching in the photolithography process to form a window with a diameter of 5 μm. After a surface of the boron nitride thin film 2 exposed in the window was processed with hydrogen plasma, in a vacuum chamber, a metal plate to be the anode electrode 5 was made to oppose to the boron nitride thin film 2 with a distance of 125 μm. The extraction electrode 4 was grounded, the cathode electrode 8 and the anode electrode 5 were applied with bias respectively, and an emission current was measured at a vacuum degree of 8×10⁻⁷ Torr or less. The anode voltage was stabilized at 500V and the cathode voltage was changed. Electron emission started by impressing 10V to the cathode electrode 8. High emission current of 0.1 mA was obtained by impressing 30V.

Electron emission characteristics were researched, and further, roughness of a film surface was evaluated by depositing the boron nitride thin film with a thickness of 10 nm on a flat silicon substrate by above mentioned method, without preparing the extraction electrode 4, and making the distance between the boron nitride thin film and the anode electrode 5 stabilized at 125 μm. The flat silicon substrate surface was evaluated to have a surface roughness of 0.3 to 0.7 nm while the boron nitride film with a thickness of 10 nm was evaluated to have a surface roughness of 0.6 to 1.2 nm. Assume an electric field concentration factor being 1 on the flat silicon substrate, and the electron affinity of silicon (4.05 eV) being comparable to a surface potential. Comparing to the assumption, when the boron nitride with a thickness of 10 nm is used, the electric field concentration factor is evaluated as 10—actually, it is overestimated—the height of the potential barrier is estimated about 0.6 eV. Thus, a significant and practical reduce of the height of the potential barrier becomes possible based on the present invention, and the reduction of an electron emission threshold electric field can be expected.

Introduction of a film according to the present invention other than a boron nitride film can reduce an effective potential barrier height and improve electron emission characteristics. In this embodiment, a boron nitride film was used, however, it is possible to use all materials according to the present invention other than boron nitride. In the embodiment, a boron nitride film was synthesized by the plasma assist CVD method. However, varied preparation method such as metal organic chemical vapor deposition (MOCVD) method, molecular beam epitaxial (MBE) method, sputtering method may be used.

In the present embodiment, the boron nitride thin film 2 added with sulfur impurities was used, however, a boron nitride thin film 3 added with atoms such as lithium, oxygen, silicon to be donor impurities may be also used. The same impurities may be used for compounds composed of group 3 and nitride atoms other than above mentioned boron nitride.

In this embodiment, silicon was used as material of a substrate. However, a substrate may be made by using varied types of conductors and semiconductors such as other metals, gallium arsenide, indium phosphorus, silicon carbide, gallium nitride. In this embodiment, Ti/Au was used for a metal for the extraction electrode 4. However, Cr instead of Ti, or various metals instead of Au may be also used. If a semiconductor substrate is used, any metals that can form an Ohmic electrode may be used as a metal for the cathode electrode 8. If a conductor substrate is used, a substrate itself may be used as a cathode electrode.

(Embodiment 2)

FIG. 2 is a schematic cross-sectional view of a second embodiment of an electron-emitting device according to the present invention. The electron-emitting device formed a spint-type spire shape on the silicon substrate 1 provided with the boron nitride carbon film of the present invention is composed of a substrate 21, a boron nitride carbon thin film 22, a SiOx film 23, an extraction electrode 24, an anode electrode 25, a power source 26, 27, a cathode electrode 28 and a spire shape 29.

The boron nitride carbon thin film 22 according to the present invention is formed at the spire shape 29 using an n-type silicon substrate 1 (111) on which the spire shape part 29 having the electrode 24. A 10 nm of the boron nitride carbon thin film 22 (composition ratio, boron 0.4, carbon 0.2, nitrogen 0.4) was deposited using boron trichloride, methane and nitrogen gas by the plasma assist chemical vapor deposition method. Sulfur atoms were added to the boron nitride carbon thin film 22 to make a concentration of 1×10¹⁸ cm⁻³. Al (500 nm) as the cathode electrode 28 was electron-beam evaporated on the backside of the silicon substrate 1. After processing a surface of the boron nitride carbon thin film 22 with hydrogen plasma, in a vacuum chamber, a metal plate to be the anode electrode 25 was made to oppose to the spire shape part 29 having the boron nitride carbon thin film 22 at a distance of 125 μm. Extraction electrode 24 was grounded, the cathode electrode 28 and the anode electrode 25 were applied with bias respectively, and an emission current was measured at a vacuum degree of 8×10⁻⁷ Torr or less. The anode voltage was stabilized at 500V and the cathode voltage was changed. A high emission current of 0.1 mA was obtained by impressing 20V to the cathode electrode 28.

In this embodiment, a boron nitride carbon thin film was used, however, other materials mentioned above such as boron nitride may be used.

(Embodiment 3)

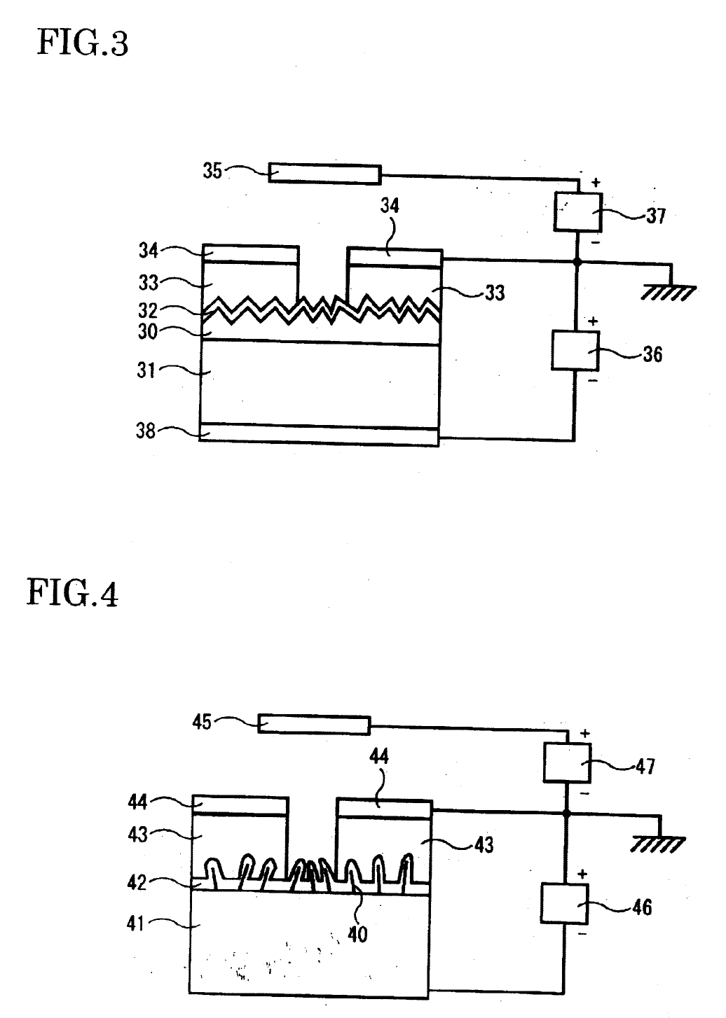

FIG. 3 is a schematic cross-sectional view of a third embodiment of an electron-emitting device according to the present invention. An electron-emitting device of embodiment 3 is composed of a substrate 31 onto which an n-type gallium nitride layer 30 is formed, boron nitride carbon thin film 32, SiOx film 33, extraction electrode 34, anode electrode 35, power source 36, 37, cathode electrode 38.

A wafer wherein the n-type gallium nitride layer 30 added silicon was grown by 1 μm on the n-type silicon substrate 31 (111) by the metal organic chemical vapor deposition was used as a substrate. Hydrogen plasma is generated by microwave to process a surface of the gallium nitride layer 30. Processing was performed for five minutes by setting a microwave output to 300W, hydrogen flow to 50 sccm and gas pressure to 40 Torr. A flat surface of the gallium nitride layer 30 changes into a surface with irregularities of several decades nm. A 10 nm of the boron nitride carbon thin film 32 (composition ratio, boron 0.4, carbon 0.2, nitrogen 0.4) was deposited using boron trichloride, methane and nitrogen gas by the plasma assist chemical vapor deposition method thereon. Sulfur atoms were added to the boron nitride carbon thin film 32 to make a concentration of 1×10¹⁸ cm⁻³. Then, 800 nm of the SiOx thin film 33 and Ti (20 nm)/Au (50 nm) as a metal for the extraction electrode 34 were formed with the electron-beam evaporation method on the boron nitride carbon thin film 32. Further, Al (500 nm) as the cathode electrode 38 was electron-beam deposited on the backside of the silicon substrate 31. After that, a metal for the extraction electrode 34 and the SiOx thin film 33 were removed by etching in the photolithography process to form a window with a diameter of 5 μm. After a surface of the boron nitride thin film 32 exposed in the window was processed with hydrogen plasma, in a vacuum chamber, a metal plate to be the anode electrode 35 was made to oppose to the boron nitride carbon thin film 32 with a distance of 125 μm. The extraction electrode 34 was grounded, bias was applied to the cathode electrode 38 and the anode electrode 35 respectively, and an emission current was measured at a vacuum degree of 8×10⁻⁷ Torr or less. An anode voltage was stabilized at 500V and a cathode voltage was changed. A high emission current of 0.1 mA was obtained by impressing 30V to the cathode electrode 38.

In this embodiment, irregularities were prepared on a surface by using hydrogen plasma processing. Gases including oxygen, chlorine or fluorine may be also used for gases to generate plasma for forming irregularities on a surface.

(Embodiment 4)

FIG. 4 is a schematic cross-sectional view of a fourth embodiment of an electron-emitting device according to the present invention. This is the electron-emitting device wherein a carbon nanofiber 40 and a boron nitride carbon thin film according to the present invention are formed on a metal substrate 41, composed of a substrate 41, a boron nitride carbon thin film 42, a SiOx film 43, an extraction electrode 44, an anode electrode 45, and a power source 46 and 47.

The carbon nanofiber 40 was formed on the metal substrate 41, on which the boron nitride carbon thin film 42 according to the present invention was formed. A 10 nm of the boron nitride carbon thin film 42 (composition ratio, boron 0.4, carbon 0.2 and nitrogen 0.4) was deposited using boron trichloride, methane and nitrogen gas by the plasma assist chemical vapor deposition method thereon. Sulfur atoms were added to the boron nitride carbon thin film 42 by concentration of 1×10¹⁸ cm⁻³. Then, 800 nm of the SiOx thin film 43 and Ti (20 nm)/Au (500 nm) as a metal for the extraction electrode 44 were formed with the electron beam deposition method on the boron nitride carbon thin film 42. After that, a metal for the extraction electrode 44 and the SiOx thin film 43 were removed by etching in the photolithography process to form a window with a diameter of 5 μm. After a surface of the boron nitride thin film 42 exposed in the window was processed with hydrogen plasma, in a vacuum chamber, a metal plate to be the anode electrode 45 was made to oppose to the boron nitride carbon thin film 42 at a distance of 125 μm. The extraction electrode 44 was grounded, the metal substrate 41 was used as a cathode electrode, bias was applied to the metal substrate 41 and the anode electrode 45 respectively, and an emission current was measured at a vacuum degree of 8×10⁻⁷ Torr or less. An anode voltage was stabilized at 500V and a cathode voltage was changed. A high emission current of 0.1 mA was obtained by impressing 10V to the metal substrate 41.

In embodiments 2 to 4, as materials of an electron emission part shown in embodiment 1, it is possible to use any one of compounds of group 3 atoms according to the present invention and nitrogen atoms, and oxides including nitrogen-boron-carbon, boron carbide, carbon nitride, boron. In embodiments 1 to 4, two or more electron emission parts may be prepared on a single substrate to realize an array.

(Embodiment 5)

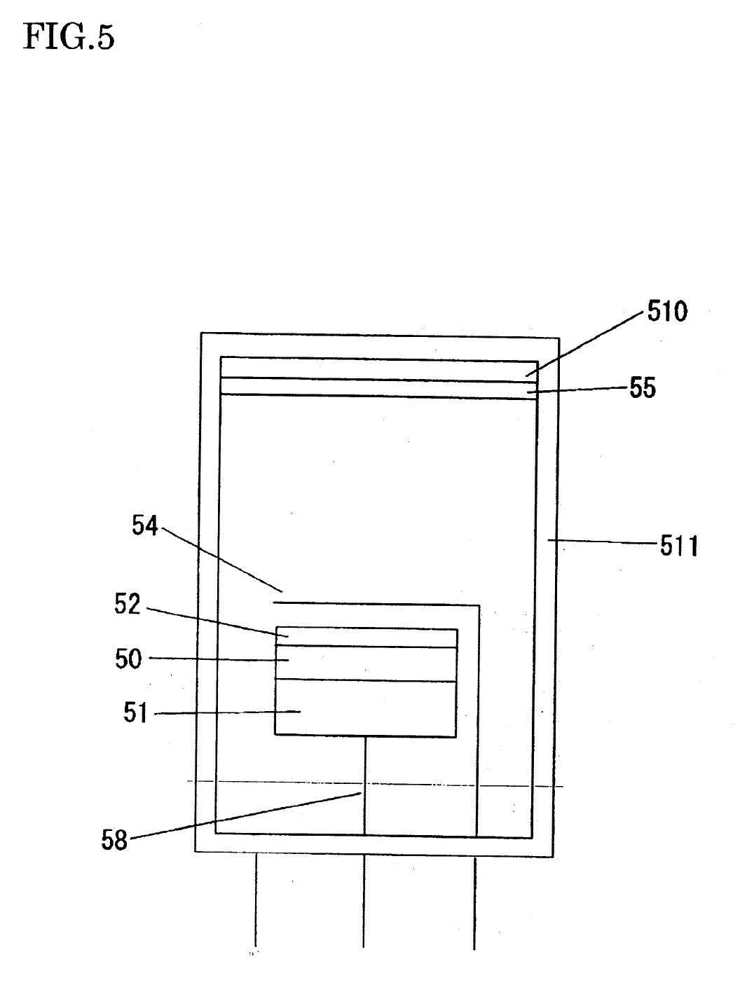

FIG. 5 is a schematic cross-sectional view of a fifth embodiment of a light-emitting element using an electron-emitting device according to the present invention. This is a light-emitting element (lamp) wherein a carbon nanofiber 50 and boron nitride carbon thin film according to the present invention are formed on a metal substrate 51, composed of a substrate 51, a boron nitride carbon thin film 52, an extraction an electrode 54, an anode electrode 55, a cathode electrode 58, a fluorescent material 510, and a glass tube 511.

The carbon nanofiber 50 is made on the metal substrate 51, on which the boron nitride carbon thin film 52 according to the present invention is formed. A 10 nm of the boron nitride carbon thin film 52 (composition ratio, boron 0.4, carbon 0.2 and nitrogen 0.4) was deposited using boron trichloride, methane and nitrogen gas by the plasma assist chemical vapor deposition method. Sulfur atoms were added to the boron nitride carbon thin film 52 by concentration of 1×10¹⁸ cm⁻³. The element was put into the glass tube 511 having the mesh extraction electrode 54 and the anode electrode 55 formed on the fluorescent material 510 and vacuum-sealed. By impressing 400V to the extraction electrode 54 against the cathode electrode 58 and 10 kV to the anode electrode 55, a current of 500 μA was obtained and a light emission was observed.

(Embodiment 6)

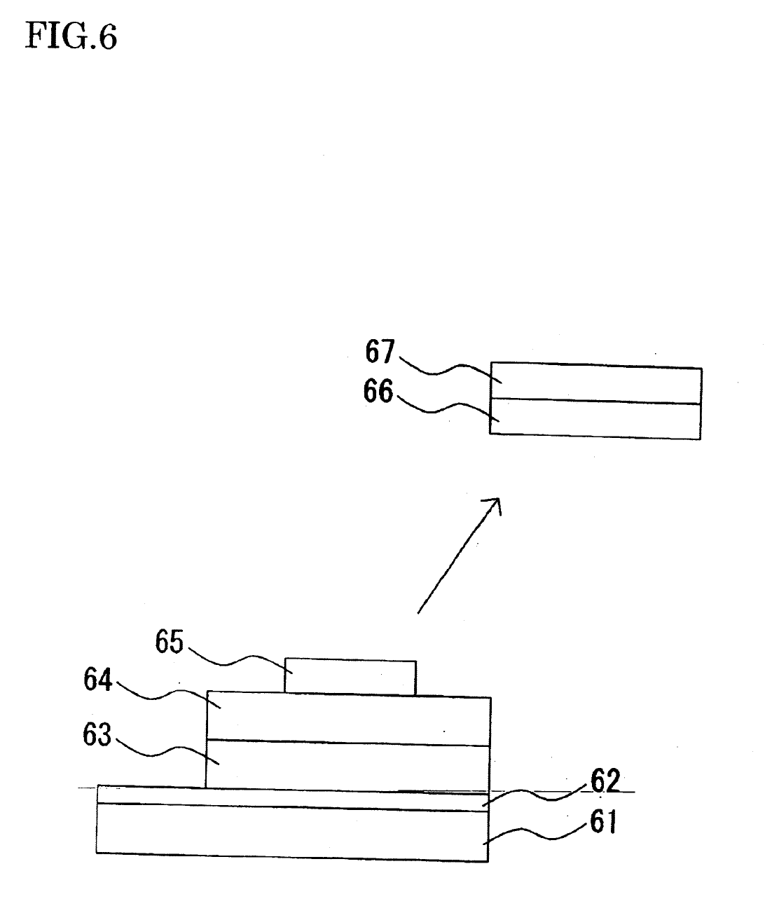

FIG. 6 is a schematic cross-sectional view of a sixth embodiment of an organic light-emitting element using an electrode according to the present invention. An anode 62 using an ITO transparent electrode is formed on a glass substrate 61, on which a hole transporting layer 63, an emitting layer 64 are formed using an organic thin film. A cathode 65 is composed of a boron nitride thin film 66 and a metal (lithium or magnesium) 67 with a smaller work function. Using a cathode according to the present invention improves injection efficiency of electron and provides an organic light-emitting element with luminescence characteristics improved.

Effect of the Invention

As mentioned above, efficiency of emission and injection of carrier is improved with an electrode having a film including any one of atoms such as oxygen, nitrogen, carbon, silicon, boron that have space charge in a film according to the present invention. An electron-emitting device with an electrode according to the present invention enables operations with lower voltage and higher current. Those effects and reliability are improved by forming irregularities, amorphous forms, and fibrous substances on a surface of a conductive material. By this, a high-efficiency electron-emitting device is provided. It is efficient as a key device in a material evaluation device and light-emitting device using a display device, electron beam photolithography machine, image pickup device. Making an organic light-emitting device by using an electrode according to the present invention improves luminance and allows wide range of practical applications as a display unit.

What is claimed is:

1. An electrode composed of a conductive material and a film having space charge

2. An electrode according to claim 1, wherein said conductive material is composed of any one of metal, semiconductor, and graphite

3. An electrode according to claim 1 or 2, wherein a surface of said conductive material has irregularities or a spire shape

4. An electrode according to claim 1 or 2, wherein a surface of said conductive material has amorphous or fibrous metal, semiconductor or graphite

5. An electrode according to any one of claims 1 to 4, wherein a surface of said conductive material has any one of amorphous, crystal grain boundary or impurity atoms

6. An electrode according to any one of claims 1 to 4, wherein a thickness of said film is 50 nm or less

7. An electrode according to any one of claims 1 to 6, wherein said film includes any one of atoms such as nitrogen, carbon, silicon, oxygen, and boron

8. An electron-emitting device using an electrode according to any one of claims 1 to 7

9. A material evaluation device using a field emission display, an electron beam exposure, a microwave traveling-wave tube, an image pickup device or an electron beam using an electron-emitting device according to claim 8.

10. A light-emitting device using an electron-emitting device according to claim 8

11. An illumination device, a backlight device of a liquid crystal display, and an indicator lamp using a light-emitting device according to claim 10

12. A plasma display using an electrode according to any one of claims 1 to 7 as an electrode of a discharge cell

13. An organic light-emitting device using an electrode according to any one of claims 1 to 7

14. A display device using an organic light-emitting device according to claim 13
